(19) United States
(12) Patent Application Publication
(10) Pub. No.: US 2007/0150682 A1
(43) Pub. Date: Jun. 28, 2007

(54) Data processing apparatus maintaining consistency of operation

(76) Inventors: Naruhiko Ogasawara, Chiba (JP); Nobuyuki Iwata, Kanagawa (JP); Hiroya Uruta, Tokyo (JP); Takahiro Hirakawa, Kanagawa (JP); Naohiko Kubo, Tokyo (JP)

Correspondence Address: HARNESS, DICKEY & PIERCE, P.L.C., P.O. BOX 8910, RESTON, VA, 20195, US

(21) Appl. No.: 11/633,066

(22) Filed: Dec. 4, 2006

(30) Foreign Application Priority Data
Dec. 5, 2005 (JP) 2005-350171

(51) Int. Cl. G06F 12/14

(52) U.S. Cl. 711/163

(57) ABSTRACT

A data processing apparatus includes a memory unit configured to store data received from an information processing apparatus, a receiving unit configured to receive operation requests, though respective interfaces, with respect to the data stored in the memory unit, an authenticating unit configured to authenticate a requester of an operation request, an operation performing unit configured to perform an operation according to an operation request received by the receiving unit only if the authentication unit successfully authenticates a requester of the operation request when the data on which the operation is performed requires authentication, and an operation prohibiting unit configured to prohibit the operation performing unit from performing a first operation corresponding to a first requester on given data until a second operation is completed if the authenticating unit successfully authenticates a second requester requesting the second operation to be performed on the given data.

### BACKGROUND OF THE INVENTION

1. Field of the Invention

The present invention relates to a data processing apparatus for storing data received from an information processing apparatus and for processing the data in response to instruction sent from an external source, a program for causing a computer to control such data processing apparatus, and a computer-readable record medium having such a program recorded therein.

2. Description of the Related Art

Data processing apparatus that stores data such as image information transmitted from an information processing apparatus and that processes the data in response to instruction received from an external source is conventionally known.

In an office equipment such as a printer or copier, for example, image information may not simply be printed when print instruction is given from an external source or when the image information is scanned by a scanner, but may be stored in a storage device. When a large number of copies need to be printed, a first copy is printed and checked, and, upon the checking, the remaining copies may be printed. In such a case, further, fixed document format may be reused. Such functions are sometimes provided in office equipments. There are also equipments in which various functions such as the removal of stored image information and the reviewing of the detailed information are provided in addition to the print function.

There is also a known configuration in which a password is set to image information, and an authentication check is performed by use of the password when instruction for processing the image information is given, followed by performing the processing only if the authentication check provides confirmation. Patent Document 1 discloses an information processing apparatus that is a data processing apparatus equipped with such function.

[Patent Document 1] Japanese Patent Application Publication No. 11-45034

In recent years, connecting data processing apparatus to plural external information processing apparatuses via a network has been becoming a frequent occurrence. In such configuration, an instruction to process data stored in the data processing apparatus may not only come from the operation panel of the data processing apparatus, but also come from an external information processing apparatus.

In this situation, there may be a case in which plural users attempt to process the same data at the same time. As a result, the consistency of operation may not be guaranteed due to conflicting operations.

Accordingly, there is a need for a data processing apparatus that can maintain the consistency of operation by preventing the occurrence of conflicting operations even when multiple requests to process stored data are received from a plurality of interfaces.

### SUMMARY OF THE INVENTION

It is a general object of the present invention to provide a data processing apparatus that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a data processing apparatus particularly pointed out in the specification in such full, clear, concise, and exact terms as to enable a person having ordinary skill in the art to practice the invention.

To achieve these and other advantages in accordance with the purpose of the invention, the invention provides a data processing apparatus, which includes a memory unit configured to store data received from an information processing apparatus, a receiving unit configured to receive operation requests, though respective interfaces, with respect to the data stored in the memory unit, an authenticating unit configured to authenticate a requester of an operation request, an operation performing unit configured to perform an operation according to an operation request received by the receiving unit only if the authentication unit successfully authenticates a requester of the operation request when the data on which the operation is performed requires authentication, and an operation prohibiting unit configured to prohibit the operation performing unit from performing a first operation corresponding to a first requester on given data until a second operation is completed if the authenticating unit successfully authenticates a second requester requesting the second operation to be performed on the given data.

According to another aspect of the present invention, a data processing apparatus includes a memory unit configured to store data received from an information processing apparatus, a receiving unit configured to receive operation requests, though respective interfaces, with respect to the data stored in the memory unit, an authenticating unit configured to authenticate a requester of an operation request, and an operation performing unit configured to perform an operation according to an operation request received by the receiving unit only if the authentication unit successfully authenticates a requestor of the operation request when the data on which the operation is performed requires authentication, wherein the operation performing unit is configured to perform a given operation corresponding to a given operation request from a given requester upon successful authentication of the given requester requesting the given operation on given data and to continue to perform the given operation, even upon modification to information used in the authentication, until the given operation is completed as requested by the given requester authenticated prior to such modification.

According to another aspect of the present invention, a data processing apparatus includes a memory unit configured to store data received from an information processing apparatus, a receiving unit configured to receive operation requests, though respective interfaces, with respect to the data stored in the memory unit, an authenticating unit configured to authenticate a requester of an operation request, an operation performing unit configured to perform an operation according to an operation request received by the receiving unit only if the authentication unit successfully authenticates a requester of the operation request when the data on which the operation is performed requires authentication, and a unit configured to cause the data processing unit to enter a specific operation mode for requesting an operation in response to a request from a requester, wherein if a transition to the specific operation mode is made in response to a given request from a given requester, the authenticating unit is configured to authenticate the given requester by use of information used as of a time of the transition to the specific operation mode until the specific operation mode is completed.

According to at least one embodiment of the present invention, the data processing apparatus can maintain the consistency of operation by preventing the occurrence of conflicting operations even when multiple requests to process stored data are received from a plurality of interfaces.

According to at least one embodiment of the program of the present invention, further, a computer is made to control a data processing apparatus to achieve the functions as described above, thereby providing the same advantages.

According to at least one embodiment of the record medium of the present invention, further, a computer without such a program is made to load and execute the program, thereby providing the same advantages.

### BRIEF DESCRIPTION OF THE DRAWINGS

Other objects and further features of the present invention will be apparent from the following detailed description when read in conjunction with the accompanying drawings: in which:

FIG. 1 is a block diagram showing a hardware configuration of an image processing apparatus that is an embodiment of a data processing apparatus of the present invention;

FIG. 2 is a drawing showing an example in which the image processing apparatus of FIG. 1 is used with external apparatuses being connected thereto;

FIG. 3 is a drawing showing another example in which the image processing apparatus of FIG. 1 is used with external apparatuses being connected thereto;

FIG. 4 is a drawing showing an example of a screen used when the image processing apparatus of FIG. 1 receives an operation instruction for a stored document through an operation panel;

FIG. 5 is a drawing showing an example of a screen that accepts the entering of a password;

FIG. 6 is a flowchart showing a process performed by a CPU in a document listing mode in the image processing apparatus according to the first embodiment of the data processing apparatus of the present invention;

FIG. 7 is a drawing showing an example of an operation performed when the image processing apparatus performing the process shown in FIG. 6 receives document operation requests at overlapping timings from a plurality of interfaces;

FIG. 8 is a flowchart showing a process performed by a CPU in the document listing mode in the image processing apparatus according to a second embodiment of the data processing apparatus of the present invention;

FIG. 9 is a drawing showing an example of an operation performed when the image processing apparatus performing the process shown in FIG. 8 receives document operation requests at overlapping timings from a plurality of interfaces;

FIG. 10 is a drawing showing an example of an operation performed when the image processing apparatus of a comparative example receives document operation requests at overlapping timings from a plurality of interfaces;

FIG. 11 is a flowchart showing a process performed by a CPU in the document listing mode in the image processing apparatus according to a third embodiment of the data processing apparatus of the present invention;

FIG. 12 is a drawing showing an example of an operation performed when the image processing apparatus performing the process shown in FIG. 11 receives document operation requests at overlapping timings from a plurality of interfaces;

FIG. 13 is a flowchart showing a process performed by a CPU in the document listing mode in the image processing apparatus according to a fourth embodiment of the data processing apparatus of the present invention;

FIG. 14 is a drawing showing an example of an operation-lock correspondence table referred to by the procedure of FIG. 13;

FIG. 15 is a drawing showing another example of the operation-lock correspondence table referred to by the procedure of FIG. 13;

FIG. 16 is a drawing showing an example of an operation performed when the image processing apparatus performing the process shown in FIG. 13 receives document operation requests at overlapping timings from a plurality of interfaces;

FIG. 17 is a flowchart showing a process performed by a CPU in the document listing mode in the image processing apparatus according to a fifth embodiment of the data processing apparatus of the present invention;

FIG. 18 is a flowchart showing queued-command processing performed at step S63 of FIG. 17; and

FIG. 19 is a drawing showing an example of an operation performed when the image processing apparatus performing the process shown in FIG. 17 receives document operation requests at overlapping timings from a plurality of interfaces.

### DESCRIPTION OF THE PREFERRED EMBODIMENTS

In the following, the best mode for carrying out the present invention will be described in detail by referring to the accompanying drawings.

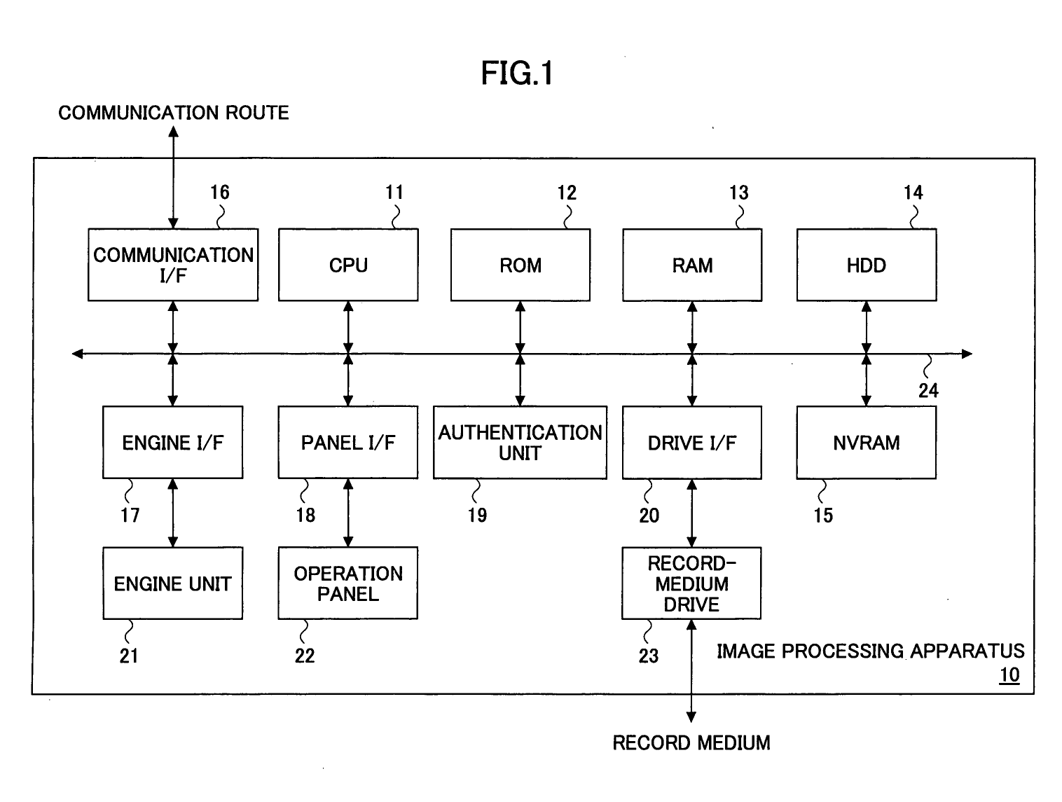

### Example of Hardware Configuration and Displayed Screen: FIG. 1 to FIG. 5

In the following, various embodiments and examples will be described. A hardware configuration and an example of a displayed screen used to enter instructions are the same throughout these embodiments and examples, and will be described first. In these embodiments and variations, the same elements will be referred to by the same numerals, even though this fact will not be reminded each time.

FIG. 1 is a drawing showing a hardware configuration of an image processing apparatus that is an embodiment of a data processing apparatus of the present invention.

As shown in FIG. 1, an image processing apparatus 10 includes a CPU 11, a ROM 12, a RAM 13, an HDD (hard-disk drive) 14, an NVRAM (nonvolatile RAM) 15, a communication I/F (interface) 16, an engine I/F 17, a panel I/F 18, an authentication unit 19, and a drive I/F 20, which are connected together through a system bus 24. Further, an engine unit 21 is provided and connected to the engine I/F 17, an operation panel 22 provided and connected to the panel I/F 18, and a record-medium drive 23 provided and connected to the drive I/F 20.

The CPU 11 is a control unit that performs central control for the entirety of the image processing apparatus 10. The CPU 11 performs various programs stored in the ROM 12 and/or HDD 14 to serve as various means such as a reception means, an operation performing means, etc., thereby serving to implement various functions relevant to the features of this embodiment.

The ROM 12 is a nonvolatile memory, and stores programs performed by the CPU 11 and fixed parameters and the like. The ROM 12 may be implemented as a rewritable memory, such that the stored data can be updated.

The RAM 13 is a memory unit for storing data to be temporarily used, for use as a work memory for the CPU 11, or for use as an image rendering memory in which image data generated by the printer engine of the engine unit 21 is laid out as bitmap data.

The HDD 14 stores programs to be executed by the CPU 11 and various data such as parameter values that need to be retained even after the power-off of the apparatus.

The HDD 14 may also store image data that is received from an external apparatus or obtained by scanning a document image by a scanner engine of the engine unit 21. Image information may be stored in any desired image information format such as a bitmap format, a JPEG (Joint Photographic Experts Group) format, a printer-language format descriptive of a picture to be drawn, and a raster code data format.

Together with the image information, a user ID and password for controlling access to the image information and an access control list for specifying user-specific access rights may also be stored.

If these information items need to be stored only temporarily, the RAM 13 may be used in place of the HDD 14.

The NVRAM 15 is a nonvolatile memory unit that is rewritable, and stores parameter values and the like for use in the control of the image processing apparatus 10.

The communication I/F 16 is an interface for providing communication between the image processing apparatus 10 and another apparatus through a communication path. The communication I/F 16 may be a network interface connected to a network for performing Ethernet (registered trademark)-based communication. When the image processing apparatus 10 communicates with another apparatus, the CPU 11 and the communication I/F 16 function together as a communication means (communication unit). The communication I/F 16 is selected as appropriate according to the communication path standard, the communication protocol that is used, etc. The communication path can be provided in any form regardless of whether wired or wireless. A plurality of communication I/Fs 16 may be provided to cope with a plurality of standards.

The engine I/F 17 is an interface that connects the engine unit 21 to the system bus 24 so as to allow control to be performed from the CPU 11.

The engine unit 21 includes a printer engine and a scanner engine.

The printer engine is an image forming means (unit) that forms an image on a paper sheet based on image data laid out as bitmap data. The method of forming such an image can be any one of known methods including an electrophotographic method. Image information received from an external source, scanned by the scanner engine, or already stored in the HDD 14 or RAM 13 is laid out as bitmap data in the image memory. An instruction to form an image is then given to the printer engine, thereby forming an image based on the image information.

The scanner engine is an image scan means (unit) that scans a document image to obtain image data of the image. The scanned image data may be stored in the HDD 14, or may be supplied directly to the printer engine for reproduction of a copy of the scanned image.

The panel I/F 18 is an interface that connects the operation panel 22 to the system bus 24 so as to allow control to be performed from the CPU 11.

The operation panel 22 includes a display unit comprised of a liquid crystal display (LCD) and light emission diodes (LED) and an operation unit comprised of various keys, buttons, and a touch panel stacked on the LCD. The display unit displays the operating states of the image processing apparatus 10, settings, messages, GUI (graphical user interface) for entering instructions, etc. The operation unit receives user operations and instructions given with respect to the image processing apparatus 10.

The authentication unit 19 is an authenticating means (unit) that performs authentication by matching authentication information such as an input password with authentication information registered in advance when authentication is required for the purpose of operation of the image processing apparatus 10. The authentication unit 19 may be implemented as a dedicated circuit if complex processing is required for authentication. Alternatively, the authentication unit 19 may be implemented as software-based functions that are provided by software executed by the CPU 11.

The drive I/F 20 is an interface that connects the record-medium drive 23 to the system bus 24 so as to allow control to be performed from the CPU 11.

The record-medium drive 23 is a data input/output means (unit), to which a detachable/attachable nonvolatile record medium such as an SD card (Secure Digital card) is attached for writing and reading of data. The CPU 11 may read a program from the record medium attached to the record-medium drive 23 for immediate execution, or may copy the program to the HDD 14 for subsequent execution.

The image processing apparatus 10 as described above may be configured to form an image on a paper sheet based on image data scanned by the scanner engine or print data received from an external apparatus via the communication I/F 16, to store the data in the HDD 14 as a document inclusive of image information, and to perform various operations such as the displaying of detailed information, printing, deletion, a password change, a document-name change, and an access-control-list change with respect to the stored document in response to instruction supplied from the user or from an external apparatus. Provision may further be made to allow the operation of the document to be only performed by a user or apparatus for which authentication is affirmative. Such authentication may be performed by use of a password.

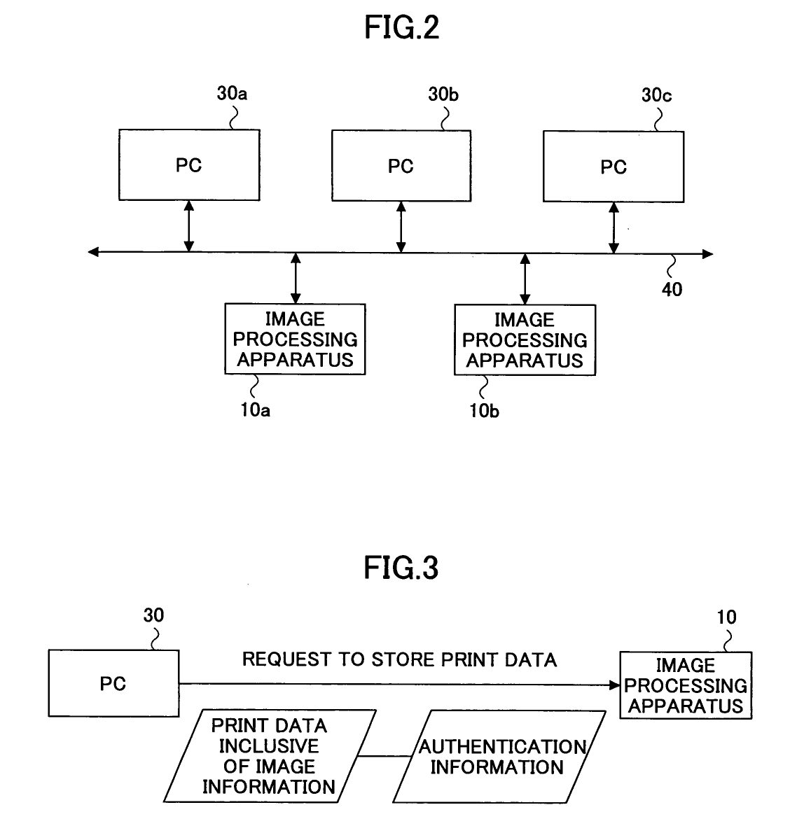

FIG. 2 and FIG. 3 are drawings showing an example in which the image processing apparatus is used with external apparatuses being connected thereto.

As shown in FIG. 2, the image processing apparatuses 10 (10a, 10b) are connected to information processing apparatuses such as PCs (personal computers) 30 (30a, 30b, 30c) via a network 40 such as a LAN so as to communicate with the PC 30.

The PC 30 uses its CPU to perform a proper application to transmit various requests to the image processing apparatus 10 according to user instruction or automatically, thereby causing the image processing apparatus 10 to perform various operations such as printing or storing of image information corresponding to the requests.

An example of such operations is shown in FIG. 3 as a request to store print data. Upon receiving this request, the image processing apparatus 10 stores, as a document in the HDD 14, the print data for which the request is made. Further, it is also possible to store a print job waiting for execution as a document in the image processing apparatus 10. This request to store print data may include authentication information in addition to the print data content that includes image information indicative of the content of an image to be formed. If such authentication information is attached, the image processing apparatus 10 permits the operation on the requested print data only when the authentication check using such authentication information provides confirmation. In so doing, an authentication may be performed only with respect to part of the operation.

In this example, a password is used as authentication information, and an authentication check involves matching a password attached to document data with a password entered at the time of request of the operation and confirming authenticity if there is a match. This password is stored in a password storage area provided in the HDD 14 in such a manner that allows the password to be associated with a document.

In response to user instruction or instruction from an external apparatus, the image processing apparatus 10 performs various operations with respect to stored documents as described above. Such instruction may be entered through the operation panel 22, or may be entered through a GUI that is displayed at the external apparatus by a browser, dedicated client program, or the like after the data of the GUI is transmitted to the external apparatus such as the PC 30. Each one of the operation panel 22, browser, and the like serves as an interface for receiving operation instruction, so that operation instructions can be received from a plurality of interfaces at the same time. Arrangements as to whether an operation corresponding to a received instruction is performed or not and how the instruction is performed at what timing differ from embodiment to embodiment.

The transmission of image data to an external apparatus may be performed by use of a communication protocol such as HTTP (HyperText Transfer Protocol). An operation instruction may be received as an execution request for a method or as a RPC (Remote Procedure Call) based on the SOAP (Simple Object Access Protocol).

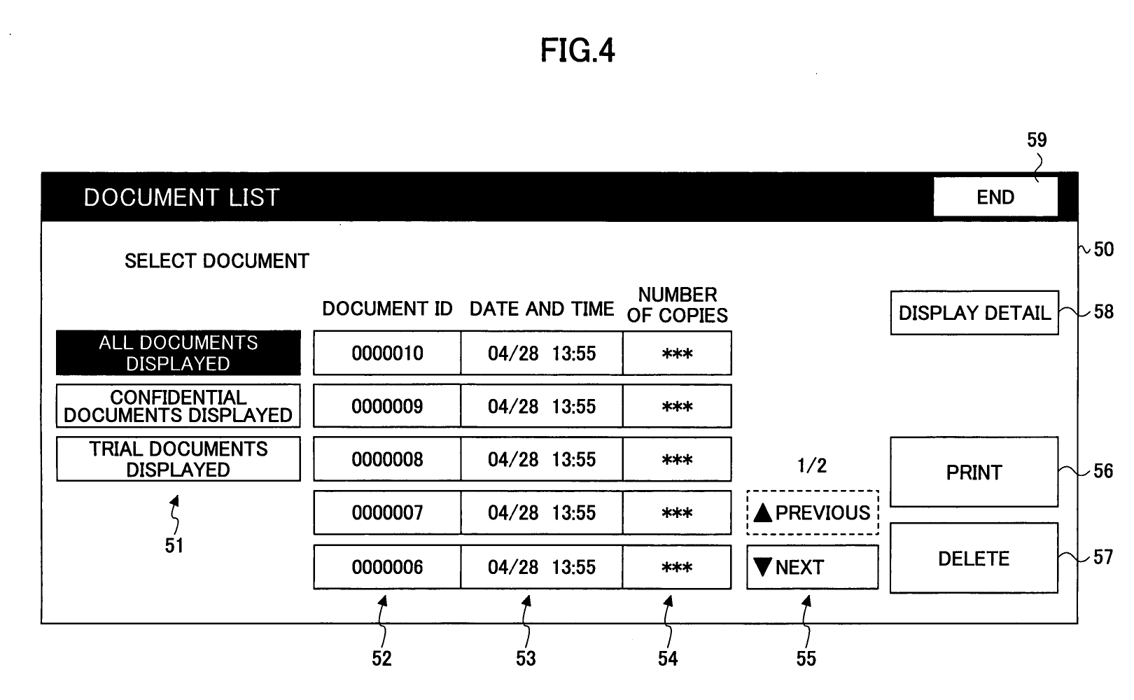

FIG. 4 is a drawing showing an example of a screen used when the image processing apparatus 10 receives an operation instruction for a stored document through the operation panel 22.

In order to receive an operation with respect to a stored document, the image processing apparatus 10 may operate in a document listing mode that is a special operation mode. When a user instructs to enter the document listing mode by pressing a designated key or the like on the operation panel 22, transition to the document listing mode occurs, so that the display of the operation panel 22 displays a document listing screen 50 as shown in FIG. 4.

This screen displays a list of either all the documents, the documents for which security attributes are set, or the documents for which trial attributes are set, among the documents stored in the image processing apparatus 10, in response to a category selected by a button of a displayed document selecting button set 51.

As document information, a document ID displaying field 52 displays document IDs, a date-and-time displaying field 53 the date and time of creation or the date and time of registration, and a copy-number displaying field 54 the number of printouts if the number of printouts is set. If the list cannot be shown within the space of one screen page, a page turning button 55 may be used to turn pages.

In the document ID displaying field 52, the date-and-time displaying field 53, or the copy-number displaying field 54, a line corresponding to a document may be pressed (touched) to select the document. In that state, a print button 56, a delete button 57, or a detail display button 58 is pressed to print, delete, or display the detail of the selected document, respectively. When the displaying of the detail is selected, detailed information regarding the document such as the document name, creator, number of pages, data size, etc., will be displayed.

Further, in the document ID displaying field 52, the date-and-time displaying field 53, or the copy-number displaying field 54, a line corresponding to a document may be touched quickly two times in succession so as to display a screen by which the change of a document name, a password, an access control list, or the like can be requested with respect to the selected document. The access control list defines the users, groups, apparatuses, etc., that are allowed to access the document. Such information may be set and stored separately for each document. Provision may be made to allow subsequent modification. In this example, a description of the process that specifies a user or apparatus at the time of authentication is omitted. When authentication that can specify a user or apparatus is to be performed, information contained in the access control list may be used to determine the access right regarding the operation of the document.

When a finish button 59 is pressed, the completion of the document listing mode is requested, thereby exiting from the document listing screen 50.

When an operation on a document is requested in the document listing mode, a password is accepted if authentication is required for the requested operation, and authentication based on the entered password will be performed.

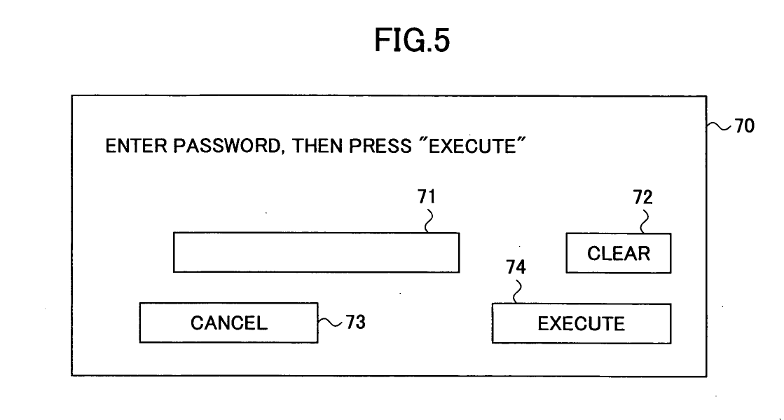

FIG. 5 is a drawing showing an example of a screen that accepts the entering of a password.

On a password entering screen 70, a password is entered in a password entering field 71 by using keys (not shown) of the operation panel 22 or a software keyboard or the like. An execute button 74 is then pressed to cause the image processing apparatus 10 to perform an authentication using the entered password. If authenticity is confirmed, the image processing apparatus 10 ascertains that the requestor who has requested an operation with respect to the document has a proper authority regarding the operation of the document, and performs the operation requested through the document listing screen 50.

A clear button 72 may be pressed to clear a password entered in the password entering field 71. A cancel button 73 may be pressed to cancel the operation and return to the document listing screen 50.

It should be noted that when a request to operate on a document is received from an external apparatus, a screen having similar functions as those described above may be used. In this case, the image processing apparatus 10 may enter the document listing mode at the timing at which a display corresponding to the document listing screen 50 is displayed on the external apparatus. Further, the apparatus may be configured to receive a request that is automatically transmitted. In such a case, there is no need to receive a request through a display screen.

The image processing apparatus 10 as described above has features in its operations that are performed during the document listing mode. In the following, a description will be given of operations during the document listing mode with respect to various embodiments and examples.

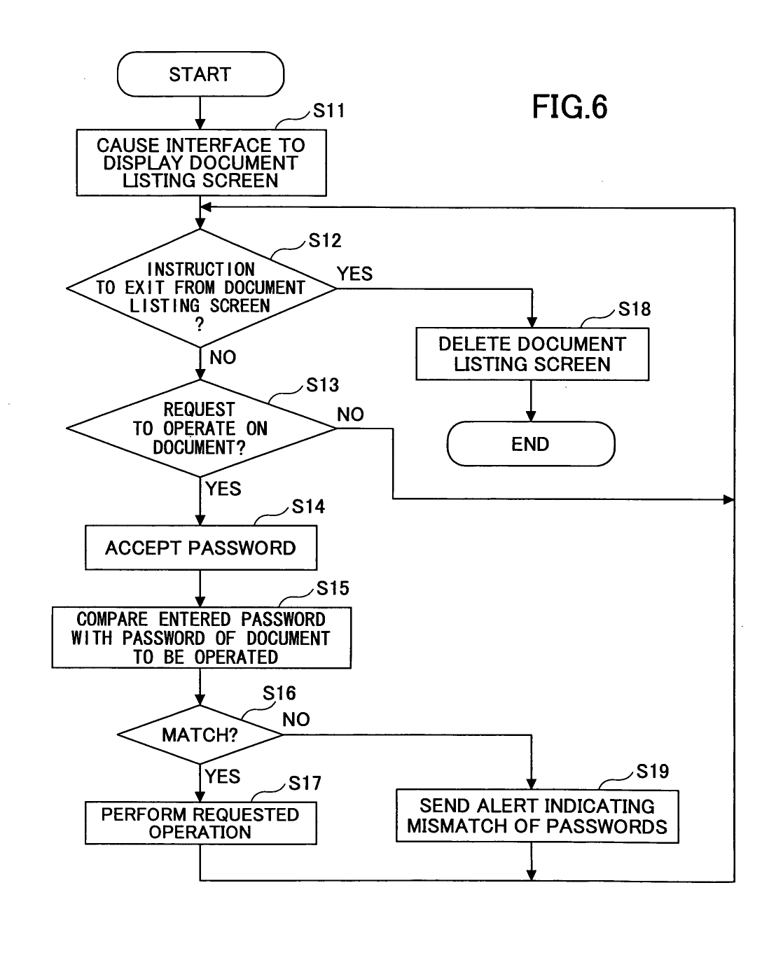

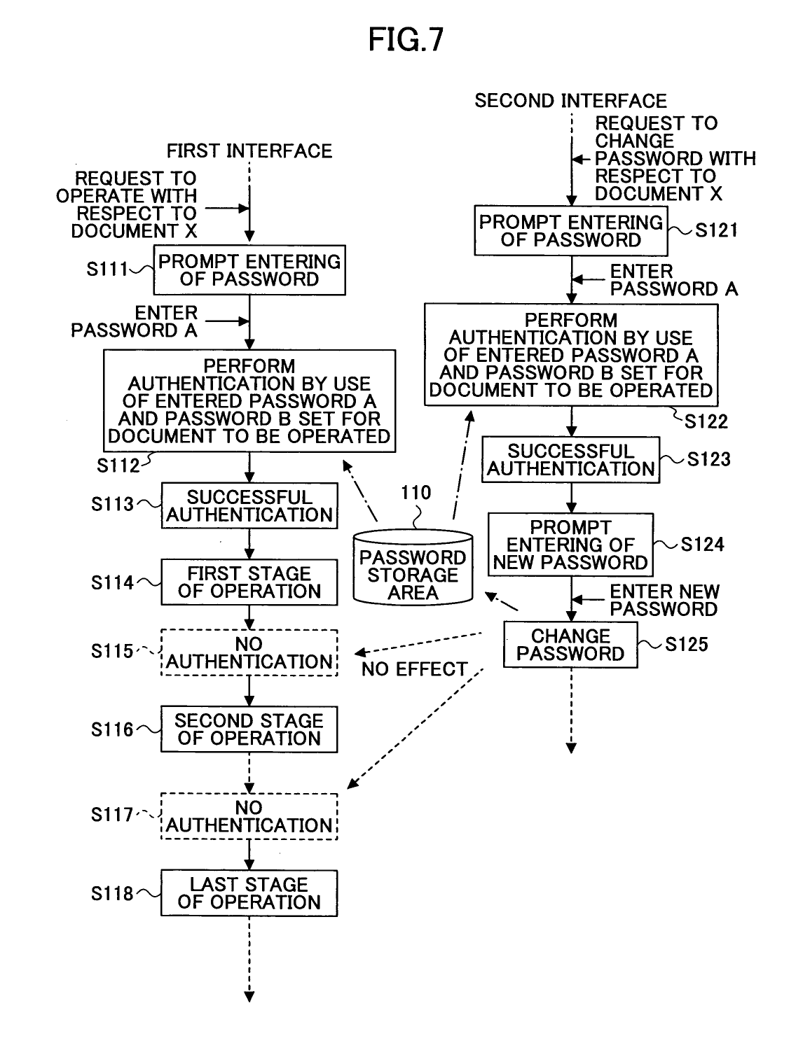

### First Embodiment: FIG. 6, FIG. 7

FIG. 6 is a flowchart showing a process performed by a CPU in the document listing mode in the image processing apparatus 10 according to the first embodiment of the data processing apparatus of the present invention.

In the image processing apparatus 10, the CPU 11 enters the document listing mode upon receiving a request to display the document listing screen, and start performing the process shown in the flowchart of FIG. 6. If requests are received from a plurality of interfaces, the process shown in the flowchart of FIG. 6 will be performed with respect to each interface. This corresponds to a case in which requests come from the operation panel 22 and an external apparatus, or a case in which requests come from a plurality of external apparatuses. Whether to enter the document listing mode can be controlled separately for each interface.

In the process shown in FIG. 6, the document listing screen is displayed at step S11 on the interface from which a display request has been received. This process displays the document listing screen 50 as shown in FIG. 4 on the operation panel 22 if the display request has been received from the operation panel 22. If the display request has been received from an external apparatus, data of a document listing screen suitable for the software used for the display request is transmitted to the requesting apparatus, thereby causing the document listing screen to be displayed. Here, processes relating to the detection of pressing of buttons, the detection of inputting of characters, and the changing of display contents in response to such detections are not illustrated.

After step S11, the procedure proceeds to step S12, at which a check is made as to whether an instruction to exit from the document listing screen is received. If such instruction has been received, the document listing screen is deleted at step S18 to finish the process, exiting from the document listing mode. Thereafter, a screen one level higher in the hierarchy than the document listing screen or a previously displayed screen is displayed, and a transition to the operation mode corresponding to the displayed screen is made. This part of the operation is not characteristic, and a description thereof will be omitted.

If no exit instruction is detected at step S12, a check is made at step S13 as to whether an instruction (request) to operate a document has been given. If there is no such request, the procedure returns to step S12 to repeat the process. If there is such request, the procedure proceeds to step S14 to receive a password from the requester in order to authenticate the requester. Such receipt may be performed by use of the password entering screen as shown in FIG. 5.

Upon the receipt of a password at step S14, the procedure proceeds to step S15, where the password entered at step S14 is compared with a password specified with respect to the document to which the request to operate a document detected at step S13 is directed.

At step S16, a check is made as to whether the comparison finds a matching result. If a matching result is obtained, the operation requested by the document operation request is performed at step S17, followed by returning to step S12 to repeat the procedure. If no matching result is obtained, an alert to indicate a password mismatch is sent at step S19 to the requestor which has requested the document operation, followed by returning to step S12 to repeat the procedure.

Through the processes described above, the CPU 11 functions as a receiving unit, authenticating unit, and operation performing unit to receive a request to operate on a document stored in the HDD 14 and to perform the requested operation only if the authenticity of the requester is confirmed.

When an external apparatus automatically transmits a request to operate on a document, also, a similar procedure may be performed to perform the requested operation upon confirming the authenticity of the requester. In this case, there is no need to cause the requesting apparatus to display the screen.

The above example has been described with respect to a case in which authentication is required for all the operations for the sake of simplicity of explanation. Provision may alternatively be made such that step S14 and step S15 are omitted with respect to an operation requiring no authentication, and step S16 is modified to produce an affirmative response (YES) at all times.

FIG. 7 is a drawing showing an example of an operation performed when the image processing apparatus 10 performing the process shown in FIG. 6 receives document operation requests at overlapping timings from a plurality of interfaces.

If the requests to display the document listing screen are received from a plurality of interfaces, the image processing apparatus 10 performs the process shown in the flowchart of FIG. 6 with respect to each of the interfaces as previously noted, thereby performing the operations corresponding to the requests received by the respective interfaces.

FIG. 7 illustrates side by side the operation responding to a request received from the first interface (e.g., the operation panel 22) and the operation responding to a request received from the second interface (e.g., browser running on the PC 30). Chain line arrows extending from the storage area signify data reading, and an chain line arrow directed toward the storage area signify data writing.

In an example shown in FIG. 7, an operation request with respect to a document X is received from the first interface, followed by receiving a right password A, and a password changing request with respect to the same document X is received from the second interface, followed by receiving the right password A.

In the operation corresponding to the first interface, the image processing apparatus 10 accept the entering of the password upon the receipt of the request of operation with respect to the document X (S111). Upon the entering of the password A, the image processing apparatus 10 compares the password A with a password B stored in the password storage area 110 associated with the document to be operated, thereby performing authentication (S112).

If the entered password A is legitimate, A and B match each other, resulting in the confirmation of authenticity (S113). The operation corresponding to the received request is then started (S114). After this, no authentication is performed (S115, S117) until a series of processes (S114 through S118) relating to the execution of the operation are all completed.

Operations performed at step S114 through step S118 correspond to the process of step S17 shown in FIG. 6.

In the operation corresponding to the second interface, the image processing apparatus 10 accepts the entering of a password and performs authentication (S121 and S122) in response to the password change request with respect to the document X as in the case of the first interface. The authentication confirms the authenticity (S123), so that a new password after the password change is received (S124) as a process responding to the password change request. Upon the receipt of the new password, the password of the document to be operated stored in the password storage area 110 is changed (S125) to the new password that is received. With this, the password change process comes to an end.

The image processing apparatus 10 of this embodiment performs operations as described above, so that once the requester requesting an operation is authenticated, the operation corresponding to the request from this requester continues to be performed until this operation comes to an end even if the password of the image information that is subjected to this operation is changed after the authentication of the requester.

As shown in FIG. 7, thus, a password change responding to a password change request may be performed before an operation corresponding to another operation request is completed. Even in this case, as long as the authentication at step S113 confirms authenticity, the operation corresponding to the operation request is thereafter performed, thereby maintaining the consistency of operation. If the password is changed prior to the authentication at step S112, the operation corresponding to the operation request will not be performed. In this case, however, the first authentication fails, thereby alerting the user of the failure at step S19 of FIG. 6. The consistency of operation is thus also maintained.

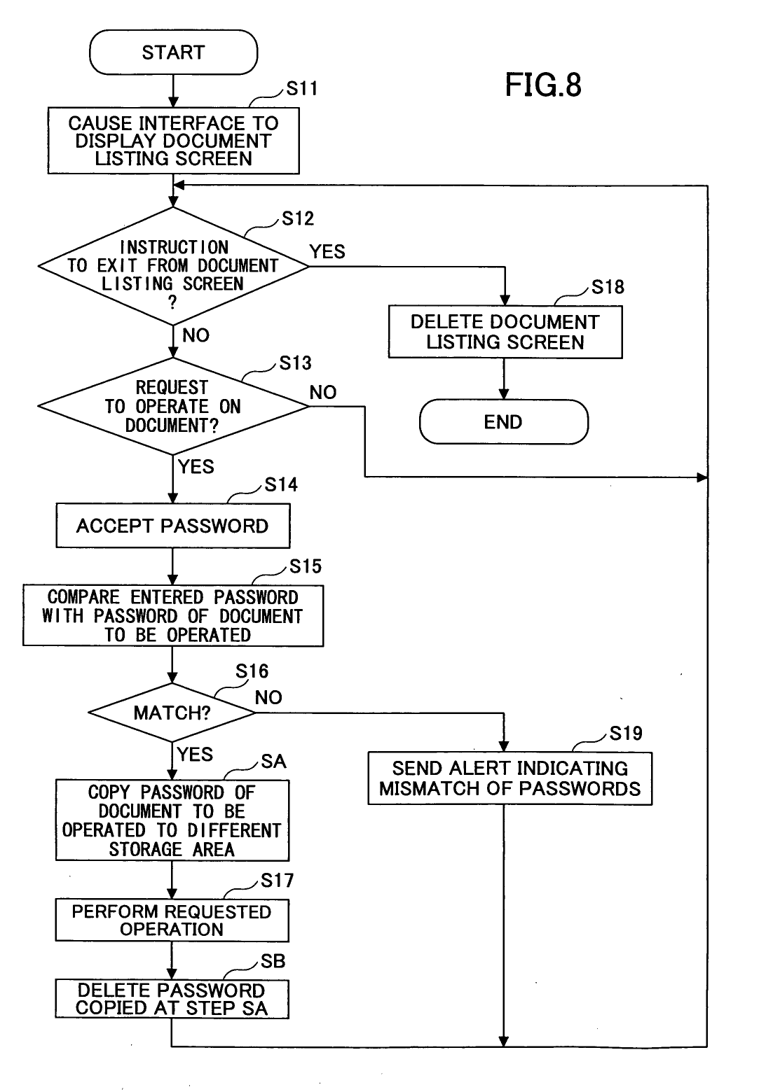

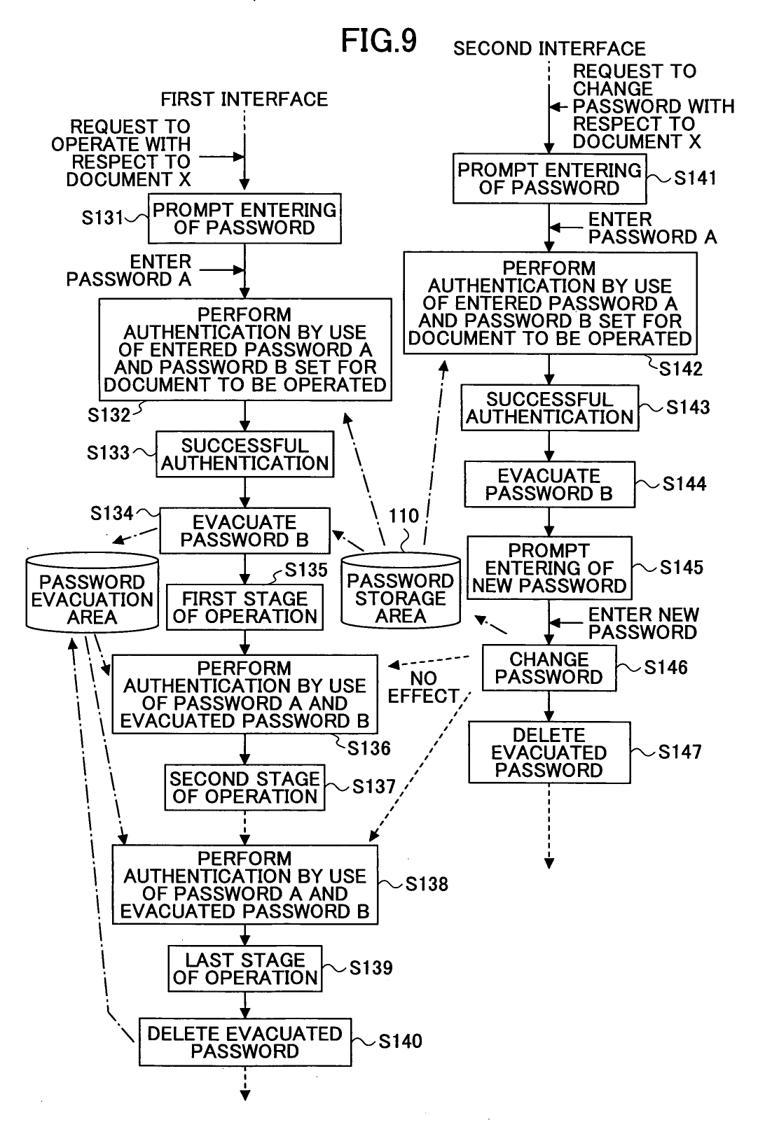

### Second Embodiment: FIG. 8, FIG. 9

FIG. 8 is a flowchart showing a process corresponding to the process of FIG. 6 as performed by a CPU in the document listing mode in the image processing apparatus 10 according to the second embodiment of the data processing apparatus of the present invention.

In the image processing apparatus 10, the CPU 11 enters the document listing mode upon receiving a request to display the document listing screen, and start performing the process shown in the flowchart of FIG. 8.

This process is substantially the same as the process shown in FIG. 6, except that, if the password of the document to be operated and the entered password match each other at step S16, the password of the document to be operated is copied at step SA to a different place for evacuation purposes, and that, after the execution of the requested operation comes to an end, the password stored at step SA is deleted (SB), followed by returning to step S12.

Further, the process relating to the performing of the requested operation at step S17 is also different from the case shown in FIG. 6. This will be described by referring to FIG. 9.

FIG. 9 is a drawing showing an example of an operation performed when the image processing apparatus 10 performing the process shown in FIG. 8 receives document operation requests at overlapping timings from a plurality of interfaces. FIG. 9 corresponds to FIG. 7.

In an example shown in FIG. 9, for the operation corresponding to the first interface, the entering of a password and authentication are performed (S131 and S132) in response to an operation request with respect to the document X as in the case of the example of FIG. 7. If the entered password is correct, the authentication succeeds (S133), so that the process corresponding to the operation request is performed. Prior to this, however, the password B set for the document to be operated is read from the password storage area 110 for storage in a password evacuation area 120. The password evacuation area 120 may be provided in the RAM 13, for example.

During a series of processes (S135 through S139) relating to the execution of the operation, authentication may need to be performed halfway through. In such a case, the password A entered at the beginning and the password B of the document to be operated as evacuated in the password evacuation area 120 will be used to perform authentication (S136, S138). It should be noted that there is no need to perform authentication at every turn. The password stored in the password evacuation area 120 is deleted (S140) after the series of processes relating to the execution of the operation.

The operation (S141 through S146) corresponding to the second interface is the same as that of step S121 through S125 shown in FIG. 7, except that the password is evacuated at step S144, and the evacuated password is deleted at step S147. It is assumed, in this case, that authentication is not necessary during the operation responding to the password change request. If authentication is necessary, however, the password A entered at the beginning and the password B evacuated at step S144 may be used to perform the authentication.

The illustration of the password evacuation area used for the operation corresponding to the second interface is omitted.

As in the first embodiment, the image processing apparatus 10 of this embodiment performs operations as described above, so that once the requester requesting an operation is authenticated, the operation corresponding to the request from this requester continues to be performed until this operation comes to an end even if the password of the image information that is subjected to this operation is changed after the authentication of the requester, thereby maintaining the consistency of operation.

With the above-described arrangement of this embodiment, also, the consistency of document can be maintained even if there is a need to perform an authentication halfway through the execution of the operation corresponding to the operation request issued with respect to the document.

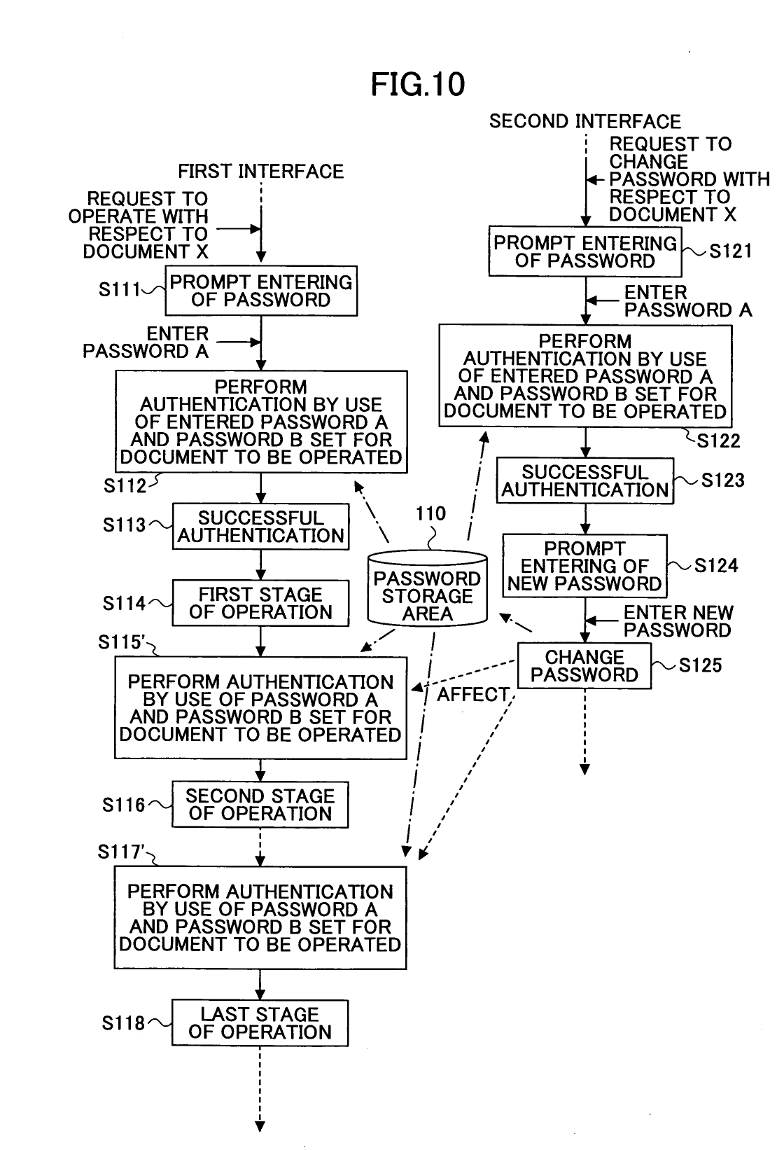

### Comparative Example: FIG. 10

In the following, a comparative example for the purpose of facilitating the understanding of the second embodiment will be described.

FIG. 10 is a drawing showing an example of an operation performed when the image processing apparatus 10 of this comparative example receives document operation requests at overlapping timings from a plurality of interfaces. FIG. 10 corresponds to FIG. 7 and FIG. 9.

The process performed by a CPU in the document listing mode in the image processing apparatus 10 is the same as that of the first embodiment as far as what is shown in the flowchart of FIG. 6 is concerned. As can be seen from the operation example shown in FIG. 10, during a series of processes (S114 through S118) relating to the execution of the operation, authentication may need to be performed halfway through. In such a case, the password A entered at the beginning and the password B of the document to be operated as stored in the password storage area 110 will be used to perform authentication (S115′, S117′).

Accordingly, if the password is changed in response to a request received through the second interface before the execution of operation proceeds to its final stage following the authentication of the user upon receiving the operation request through the first interface, authentication to be performed halfway through the execution of the operation corresponding to the first interface ends up failing due to a difference between the password of the document to be operated and the correct password A entered at the beginning. In this case, no alert indicative of the failure of authentication is given to the user, but the operation corresponding to the operation request follows the same fate as the operation that has failed authentication. Thus, the consistency of operation cannot be maintained.

In recent years, the development of new products using preexisting modules has become a frequent occurrence, especially in the case of software products. Some of such modules require authentication when data is to be exchanged between modules so as to perform an operation on a document. If such modules are used for the development of the image processing apparatus 10, the problem as described in connection with this comparative example arises.

According to the configuration of the second embodiment, on the other hand, the consistency of operation of the image processing apparatus 10 can be maintained even when a module requiring authentication for the exchange of data is used. In this case, the password evacuation area 120 which is referred to for the checking of a password of a document to be operated needs to be provided. The provision of such area, however, requires little modification to existing software. This allows an efficient product development that utilizes existing resources.

What is described above is equally applicable to the case in which authentication is required for the exchange of data between hardware modules.

It should be noted that even if a module requiring authentication for the exchange of data is used, such module may be modified so as to skip authentication in the absence of a password, thereby providing a way to bypass the authentication. With such modification, the configuration of the first embodiment may be implemented. The configuration of the second embodiment, however, may be implemented with less effort.

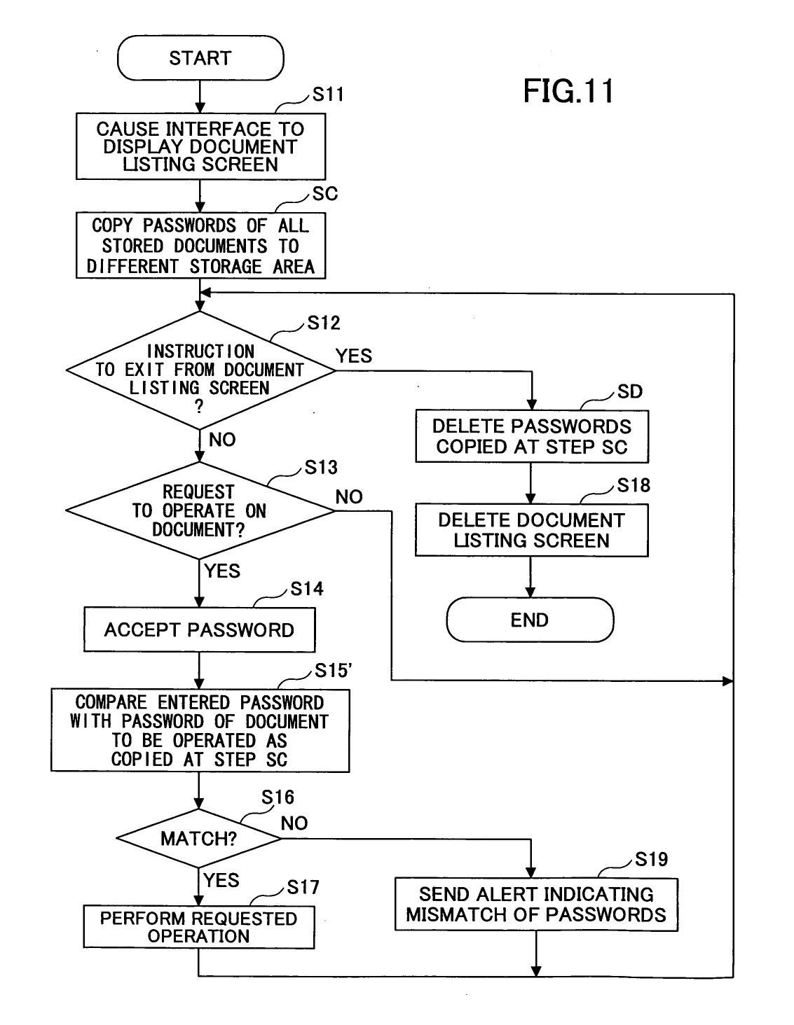

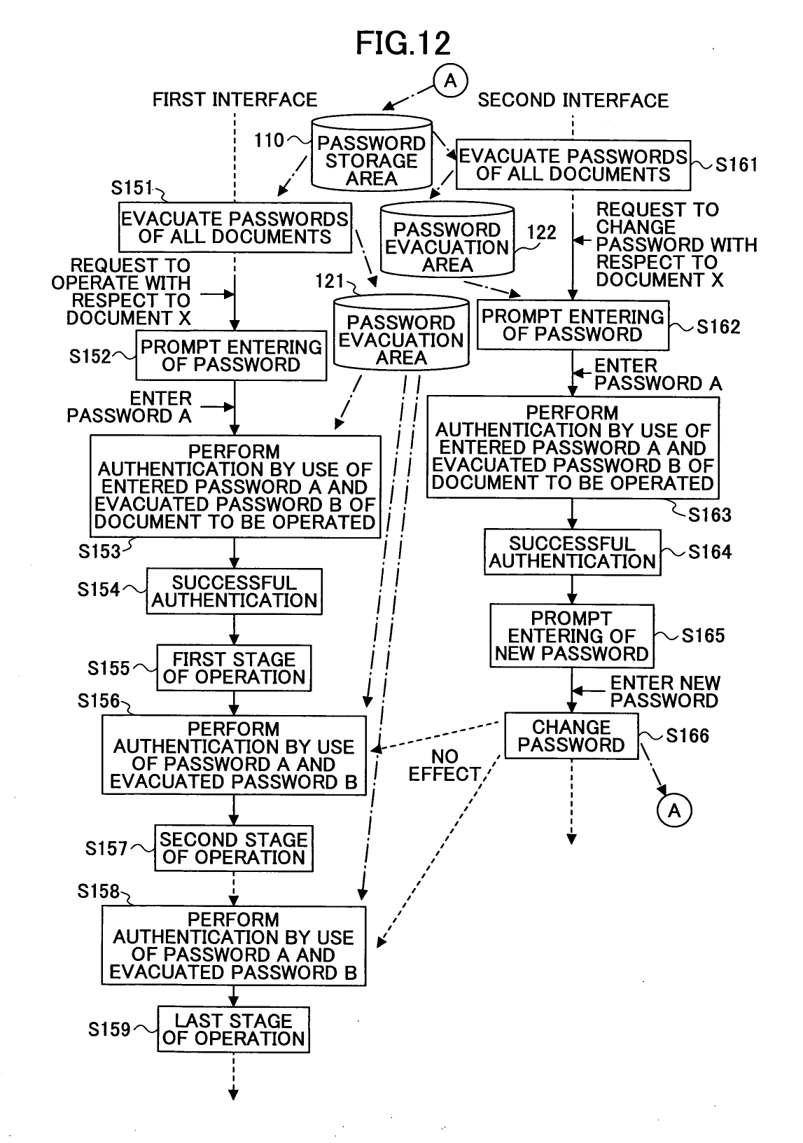

### Third Embodiment: FIG. 11, FIG. 12

FIG. 11 is a flowchart showing a process corresponding to the process of FIG. 6 as performed by a CPU in the document listing mode in the image processing apparatus 10 according to the third embodiment of the data processing apparatus of the present invention.

In the image processing apparatus 10, the CPU 11 enters the document listing mode upon receiving a request to display the document listing screen, and start performing the process shown in the flowchart of FIG. 11.

This process is substantially the same as the process shown in FIG. 6, except that when a transition to the document listing mode is made, the passwords of all the documents stored in the image processing apparatus 10 are copied (SC) to a different place after displaying the document listing screen, and that a password stored in this different place is used as a password of a document to be operated during subsequent authentication (e.g., S15′). A further difference from the process of FIG. 6 is that if an operation to exit from the document listing screen is performed at step S12, the document listing screen is deleted after deleting (SD) the passwords copied at step SC.

FIG. 12 is a drawing showing an example of an operation performed when the image processing apparatus 10 performing the process shown in FIG. 11 receives document operation requests at overlapping timings from a plurality of interfaces. FIG. 12 corresponds to FIG. 7.

In an example shown in FIG. 12, during the operation corresponding to the first interface, the passwords of all the documents are read from the password storage area 110 at the time of transition to the document listing mode, and are copied to a password evacuation area 121 for evacuation purposes (S151). Thereafter, upon an operation request with respect to the document X, the receiving of a password and authentication are performed (S152 and S153) as in the case of FIG. 7. The password used for this authentication is a password that was evacuated to the password evacuation area 121.

If the entered password A is a correct password as of the time of transition to the document listing mode, authenticity is confirmed (S154). The operation corresponding to the operation request is then performed.

During a series of processes (S155 through S159) relating to the execution of the operation, authentication may need to be performed halfway through. In such a case, the password A entered at the beginning and the password B of the document to be operated as evacuated in the password evacuation area 121 will be used to perform authentication (S156, S158).

Also in the operation corresponding to the second interface, the passwords of all the documents are read from the password storage area 110 at the time of transition to the document listing mode, and are copied to the password evacuation area 122 for evacuation purposes. This operation may be performed at different timing than the operation for transition to the document listing mode for the first interface that is performed in response to the request from the first interface. There is a possibility that some passwords were changed during this timing gap. The password evacuation area 122 for use in the operation corresponding to the second interface is thus provided separately from the password evacuation area 121 used in the operation corresponding to the first interface.

The subsequent operation (S162 through S166) is the same as that of step S121 through S125 shown in FIG. 7, except that the password of the document to be operated as stored in the password evacuation area 122 is used for authentication. It is assumed, in this case, that authentication is not necessary during the operation responding to the password change request. If authentication is necessary, however, the password A entered at the beginning and the password B evacuated to the password evacuation area 122 may be used to perform the authentication.

The image processing apparatus 10 of this embodiment performs the operation as described above, so that when a transition to an operation mode for receiving a request for document operation is made, the information used as of the time of such transition is used to authenticate the requestor requesting the transition all the time until this operation mode comes to an end.

Accordingly, when a transition to the document listing mode is made in response to a request from a given interface, and when the password is subsequently changed in response to a request from another interface as shown in FIG. 12, the access right to operate on the document by the former interface is not affected at all. This insures the consistency of operation.

With the above-described arrangement of this embodiment, also, the consistency of document can be maintained even if there is a need to perform an authentication halfway through the execution of the operation corresponding to the operation request issued with respect to the document.

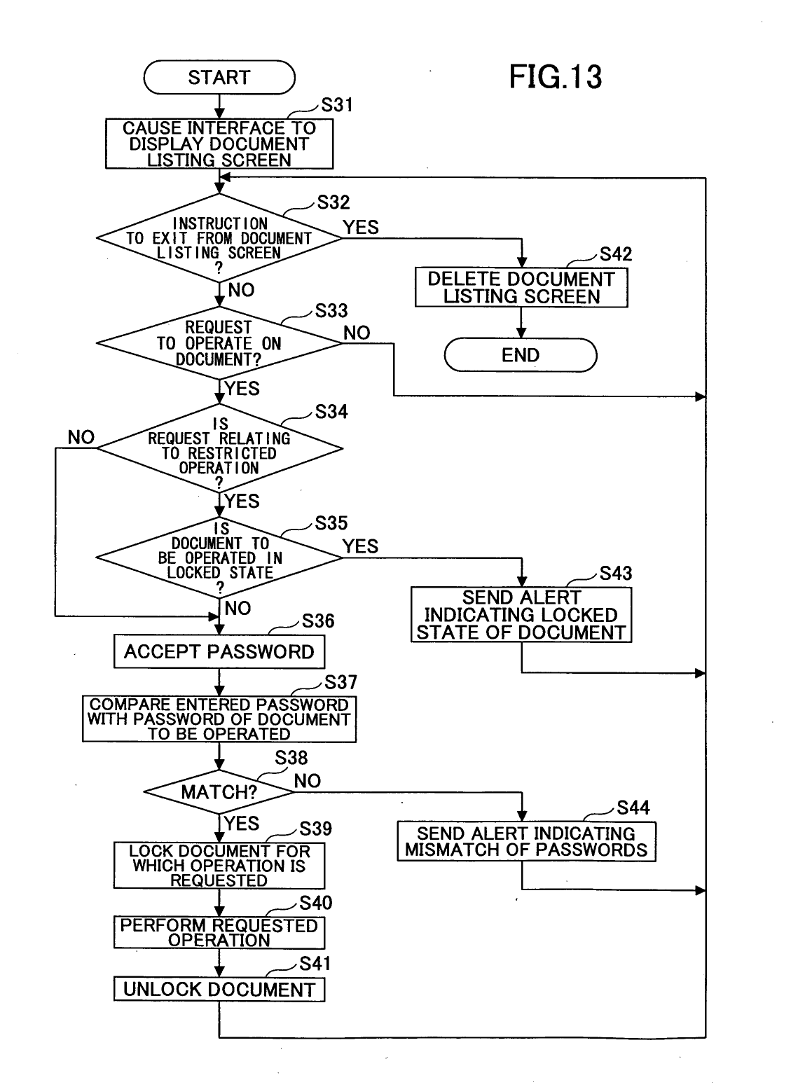

### Fourth Embodiment: FIG. 13 through FIG. 16

FIG. 13 is a flowchart showing a process corresponding to the process of FIG. 6 as performed by a CPU in the document listing mode in the image processing apparatus 10 according to the fourth embodiment of the data processing apparatus of the present invention.

In the image processing apparatus 10, the CPU 11 enters the document listing mode upon receiving a request to display the document listing screen, and start performing the process shown in the flowchart of FIG. 13.

Steps S31 through S33 and S42 of this process is the same as steps S11 through S13 and S18 shown in FIG. 6.

Upon a document operation request entered at step S33, the procedure proceeds to step S34, at which a check is made as to whether the requested operation needs to be restricted. This determination is made by referring to an operation-lock correspondence table stored in the NVRAM 15 or the like in advance.

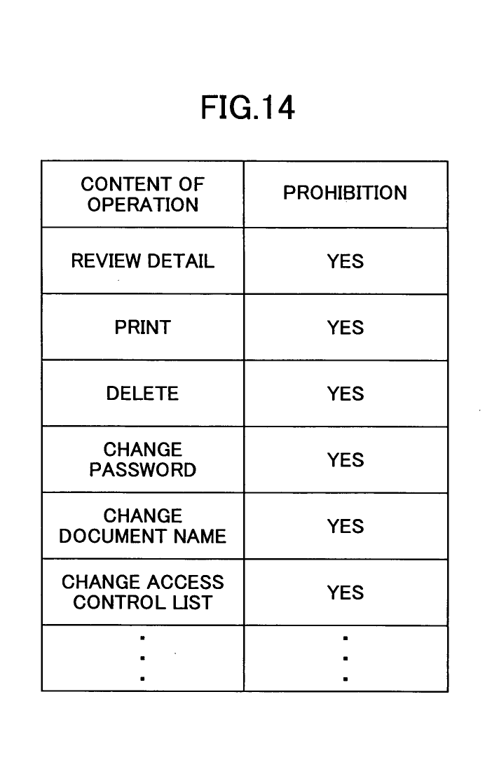

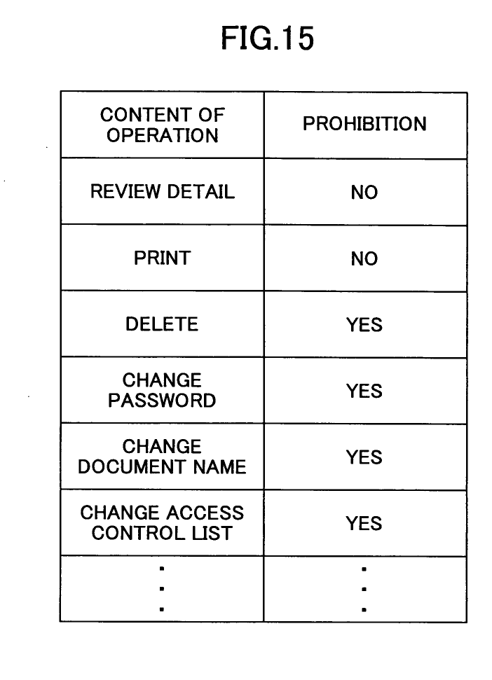

FIG. 14 and FIG. 15 are drawings showing an example of the operation-lock correspondence table.

As shown in these figures, the operation-lock correspondence table defines whether an operation requested during the document listing mode is prohibited from being performed during another operation being performed with respect to the document to be operated. The contents of the table may be set at the timing of manufacturing the apparatus, and provision may be made such that the contents can be changed according to instruction from a user or from an external apparatus.

The default settings may be made such as to prohibit all operations from being performed during another operation being performed with respect to the document to be operated, as shown in FIG. 14. With such settings, the check at step S34 of FIG. 13 produces “YES” at all times. Step S33 of FIG. 13 may thus be omitted.

Alternatively, as shown in FIG. 15, execution may be prohibited only with respect to operations that may destroy the consistency of operation if performed during another operation (inclusive of an operation of the same type), e.g., operations involving data change such as deletion, a password change, a document name change, or an access-control-list change. With this provision, an operation that only refers to data and does not affect the consistency of operation even if performed during another ongoing operation, such as reviewing of details and printing, can always be performed. This improves the convenience of the apparatus.

Further, as an example in the middle, settings may be made to prohibit part of operations that do not affect the consistency of operation.

Turning back to FIG. 13, upon “YES” at step S34, the procedure proceeds to step S35, at which a check is made as to whether the document to be operated in response to the operation request detected at step S33 is being locked or not. The term “lock” means the lock performed at step S39, which will be described in the following.

If it is not locked, it is ascertained that the operation can be performed while maintaining the consistency of operation, so that the procedure proceeds to step S36 to receive a password. If the answer to the check at step S34 is “NO”, also, it is ascertained that the operation can be performed while maintaining the consistency of operation, so that the procedure proceeds to step S36 to receive a password.

The processes of steps S36 through S38 and S44 are the same as processes of steps S14 through S16 and S19 shown in FIG. 6, and perform the receiving of a password and authentication.

Upon the confirmation of authenticity, the operation requested by the document operation request detected at step S33 is performed. Prior to this, however, the document subjected to the requested operation is locked at step S39 so as to prohibit another operation from being performed on this document until the requested operation comes to an end if the settings of the operation-lock correspondence table indicate the prohibition of such another operation. After this, the operation requested by the document operation request is performed at step S40. When the operation is completed, the lock of the document is released at step S41, followed by returning to step S32 to repeat the procedure.

If the lock is in place at step S35, the requester requesting the document operation receives an alert indicating that the requested operation cannot be performed due to the locked state of the document, followed by returning to step S32 to repeat the procedure. Such alert is beneficial since the user will learn that his/her requested operation can be performed after waiting if the ongoing operation requested through another interface comes to an end. However, alternative provision may be made to simply ignore the document operation request without issuing an alert.

Through the processes described above, the CPU 11 serves as an operation prohibiting means (unit) in addition to the receiving means, authenticating means, and operation performing means in the same manner as in the process shown in FIG. 6. According to the settings of the operation-lock correspondence table, an operation corresponding to a received operation request can be prohibited if another operation corresponding to another operation request is being performed.

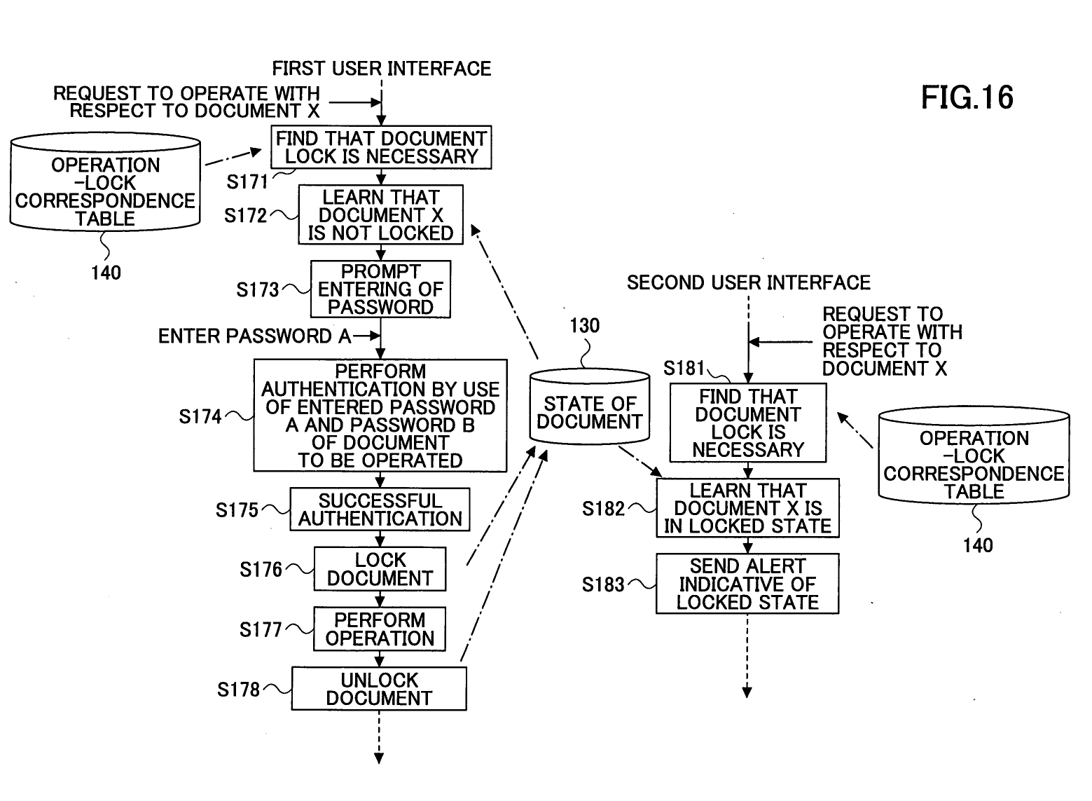

FIG. 16 is a drawing showing an example of an operation performed when the image processing apparatus 10 performing the process shown in FIG. 13 receives document operation requests at overlapping timings from a plurality of interfaces. FIG. 16 corresponds to FIG. 7.

In an example shown in FIG. 16, during the operation corresponding to the first interface, an operation-lock correspondence table 140 is referred to in response to an operation request with respect to the document X. If it is determined (S171) that operation restriction needs to be placed, a state 130 of the document X to be operated is checked. This state may be recorded as an attribute of the document X. If it is found (S172) that the document X is not locked, the receiving of a password and authentication are performed (S173 and S174) as in the case of FIG. 7.

If the entered password A is a correct password, authenticity is confirmed (S175). The operation corresponding to the operation request is then performed. Such operation is performed (S177) after the document X to be operated is locked (S176), and the lock is released when the operation comes to an end (S178). Such locking may be performed by setting the state 130 of the document X to a locked state.

In this figure, a series of processes relating to the execution of operation are not illustrated as broken down processes as in FIG. 7, but may be comprised of multiple stages as in the case of FIG. 7. Further, authentication may be performed separately for each stage as in the case of FIG. 10.

Also in the operation corresponding to the second interface, the operation-lock correspondence table 140 is referred to in response to an operation request with respect to the document X. This table may be the same as the table referred to at step S171. If it is determined (S181) that operation restriction needs to be placed, a state 130 of the document X to be operated is checked. If it is found (S182) that the document X is locked, an alert is issued (S183) to the second interface to inform that the document X requested for operation is in the locked state, without proceeding to authentication and the execution of the operation.

The image processing apparatus 10 of this embodiment performs the processes as described above, so that when an operation corresponding to a request received through a given interface starts after proper authentication, another operation corresponding to a request received through another interface will not be performed. Accordingly, the consistency of operation is maintained by avoiding the situations in which the password of the document being operated is changed, or the document is deleted during the operation.

It should be noted that the consistency of operation is maintained even if an operation is performed during another ongoing operation as long as such operation simply refers to the contents of the document such as the reviewing of detailed information or printing. Such operation does not have to be prohibited.

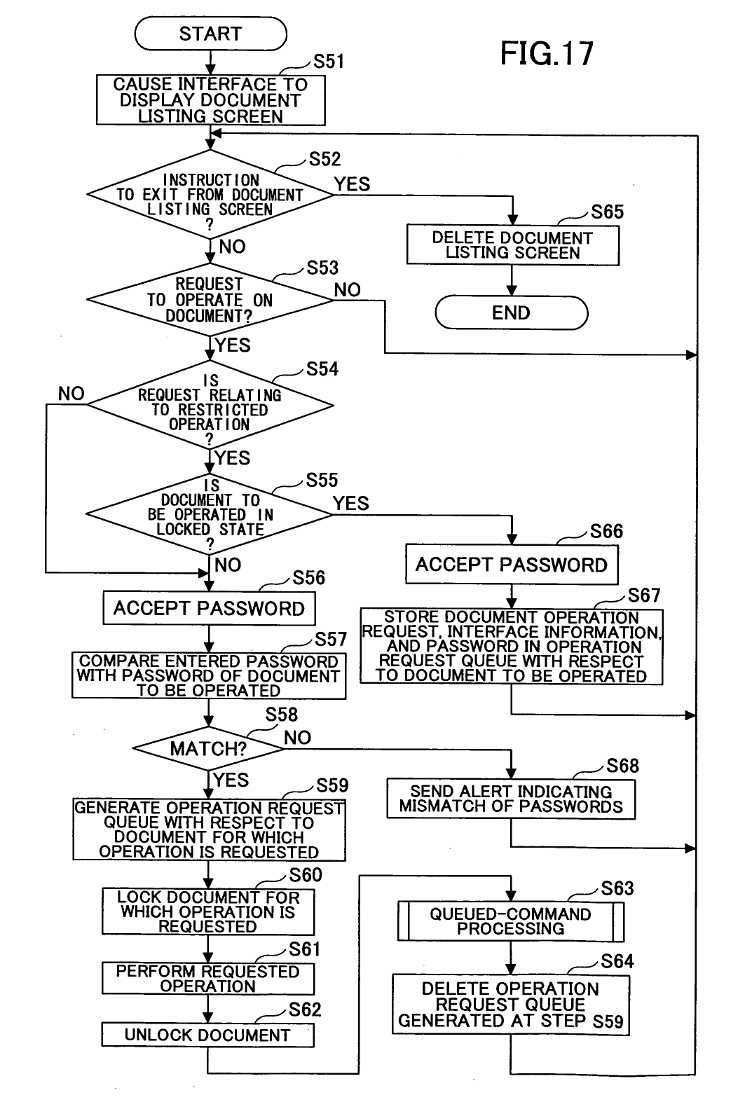

### Fifth Embodiment: FIG. 17 through FIG. 19

FIG. 17 is a flowchart showing a process corresponding to the process of FIG. 13 as performed by a CPU in the document listing mode in the image processing apparatus 10 according to the fifth embodiment of the data processing apparatus of the present invention.

In the image processing apparatus 10, the CPU 11 enters the document listing mode upon receiving a request to display the document listing screen, and start performing the process shown in the flowchart of FIG. 17.

Steps S51 through S58, S65, and S68 of this process are the same as steps S31 through S38, S42, and S44 shown in FIG. 13. The difference lies in the process performed when the operation corresponding to the operation request is performed upon successful authentication, and the process performed when the operation is not performed due to the locked state of the document to be operated.

When the operation is to be performed, an operation request queue is generated at step S59 with respect to the document for which an operation is requested, thereby arranging that an operation request with respect to this document made during the locked state is accumulated. Thereafter, the locking of the document to be operated, the execution of the operation, and the releasing of the lock are performed at steps S60 through S62 in the same manner as in steps S39 through S41 shown in FIG. 13.

At step S63, then, queued-command processing that attempts to perform operations corresponding to the operation requests accumulated in the operation request queue is performed at step S63. After completing all the processes relating to these operation requests, the operation request queue generated at step S60 is deleted at step S64, followed by returning to step S52 to repeat the procedure.

If it is found at step S55 that the document to be operated is in the locked state, the processes relating to the document operation request received at step S53 are not performed immediately. It is rather determined that the operation request should be stored in the operation request queue for subsequent execution after the completion of the ongoing operation that is being performed with respect to the document to be operated. The procedure then proceeds to step S66, at which a password to be used in authentication for the execution of the document operation request is received in advance. At step S67, the received password is assigned to the document operation request and the information indicative of the interface that has received the request, and is stored in the operation request queue with respect to the document to be operated. Thereafter, the procedure returns to step S52 to repeat the procedure.

The process shown in FIG. 17 is the same as the process shown in FIG. 6 in terms of the fact that the process is performed on an interface-specific basis. The queue for registering document operation requests at step S67 is thus different from the operation request queue generated for the ongoing process corresponding to another interface.

If the queue in which the document operation request should be registered at step S67 is no longer in existence, it is ascertained that the lock of the document to be operated has already been released. Provision may thus be made such that the procedure proceeds to step S57, at which the stored password is used to authenticate the requester of the operation, followed by performing the requested operation upon successful confirmation of authenticity. Needless to say, the generation of an operation request queue and the locking of a document are performed also in this case.

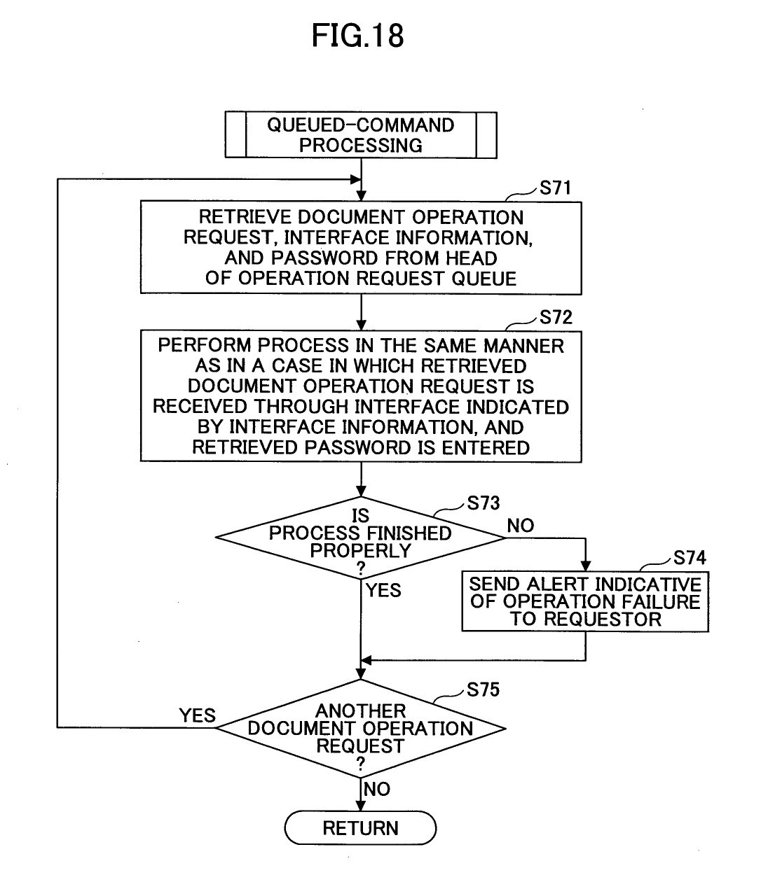

FIG. 18 is a flowchart showing queued-command processing performed at step S63 of FIG. 17.

In this processing, a document operation request, interface information, and a password are retrieved at step S71 from the head of the operation request queue. At step S72, the processes of steps S54 through S64 or through S67 of FIG. 17 are performed in the same manner as in the case in which the retrieved document operation request is received through the interface indicated by the interface information, and the retrieved password is entered for the authentication purpose.

The process of step S72 is configured to call the process of FIG. 17, so that further queued-command processing may be performed during the process of step S72, forming a nested structure.

If the procedure proceeds to step S68, or if error occurs for some other reason, the procedure proceeds to step S73 based on the determination that the process did not end properly. The reason why this is done is as follows. Even if the operation was executable as of the time at which the operation request was accumulated in the operation request queue, the operation may not be executable at the time of the process of step S72 because of a subsequent change of the password, deletion of the document to be operated, the loss of the user's access right resulting from the editing of an access control list, etc.

At step S73, a check is made as to whether the process of step S72 is completed with normal completion status. If it is completed with normal status, the procedure proceeds to step S75. If there is still a document operation request in the queue, the procedure goes back to step S71 to repeat the procedure. If there is no entry, return to the original procedure is performed.

If the completion is not normal at step S73, the procedure proceeds to step S74, at which an alert indicative of the failure of operation is issued to the requestor requesting the operation, followed by proceeding to step S75. When this happens, however, the user who made the request may not be present at the place of the interface, or the communication with the external apparatus which made the request may have already been disconnected. In consideration of this, provision may be made to refer to the information indicative of the requestor retrieved from the operation request queue and to transmit the alert through another means such as electronic mail different from the interface that receives a document operation request. If access to the interface cannot be made, another means may be used.

Through the processes described above, the CPU 11 serves as a request accumulating means (unit) in addition to the receiving means, authenticating means, operation performing means, and operation prohibiting means in the same manner as in the process shown in FIG. 13. When a request for operation that cannot be performed due to the locked state of the document is received, this request is stored in memory, and the operation corresponding to the stored request is performed after the lock of the document is released.

It should be noted that in the processes shown in FIG. 17, the queued-command processing and following removal of a queue may be provided as a separate process that is activated in response to a document-lock-release event.

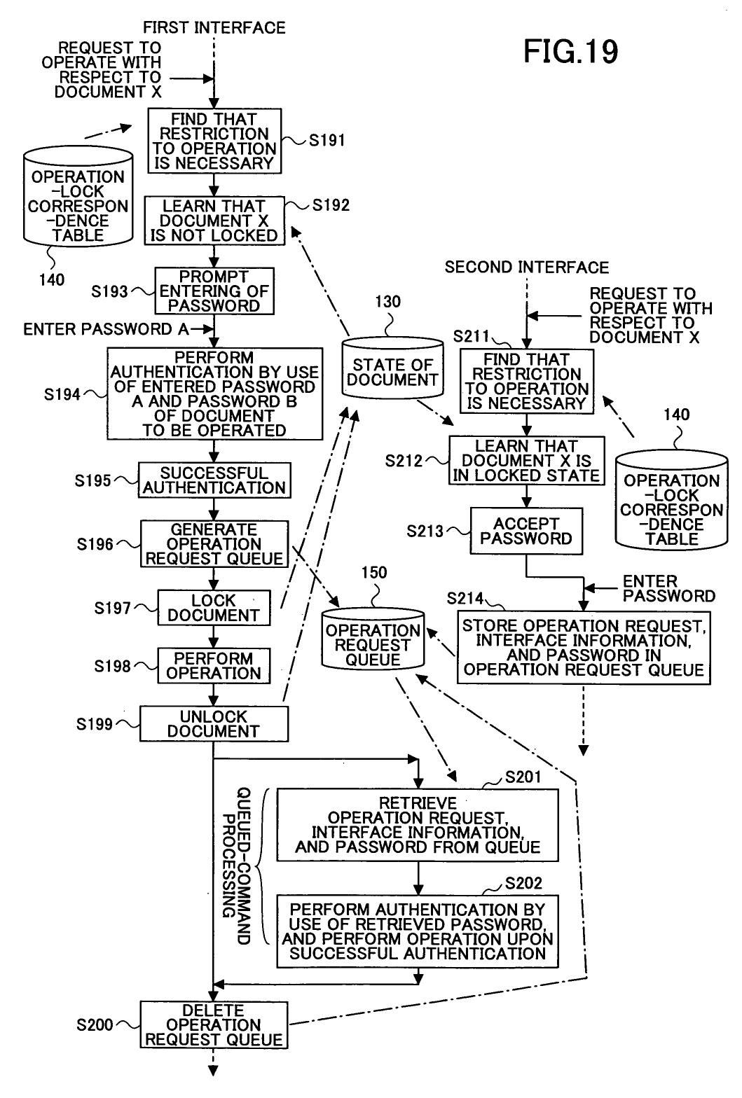

FIG. 19 is a drawing showing an example of an operation performed when the image processing apparatus 10 performing the process shown in FIG. 17 receives document operation requests at overlapping timings from a plurality of interfaces. FIG. 19 corresponds to FIG. 16.

In an example of FIG. 19, during the performing of processes corresponding to the first interface, it may be ascertained that the operation can be performed by judging the operation restriction and document state in response to an operation request with respect to the document X, as in the case of FIG. 17. In such a case, the receiving of a password and authentication are performed (S191 through S194).

If the entered password A is a correct password, authenticity is confirmed (S195). The operation corresponding to the operation request is then performed. Prior to this, however, an operation request queue 150 is generated (S196). This queue may be provided in the RAM 13. After this, the operation is performed (S198) after the document X to be operated is locked (S197), and the lock is released when the operation comes to an end (S199).

If no operation request is accumulated in the operation request queue 150, the operation request queue is deleted (S200). If there is an accumulated operation request, an operation corresponding to this operation request is performed (S201, S202).

Also in the processes corresponding to the second interface, a check is made (S211, S212) as to whether the operation can be performed by judging the operation restriction and document state in response to an operation request with respect to the document X. In this example, it is ascertained (S212) that the document to be operated is in the locked state.

In this case, the received operation request is stored in the operation request queue 150. In detail, a password for use in authentication for the execution of the operation is received (S213), and the received operation request, the password, and the interface information indicative of the second interface are stored together (S214).

The operation corresponding to the stored request will be performed by the queued-command processing (S201, S202) performed during the processes corresponding to the first interface.

The image processing apparatus 10 of this embodiment performs the processes as described above, so that the receiving of an operation request is performed in the same manner as when the operation will be able to be performed immediately, even in the case in which, during an operation with respect to a given document, another operation corresponding to a request received through another interface will not be performed with respect to the same document. Accordingly, the same advantages as those of the fourth embodiment are provided, and, further, an operation request can be accepted without making the user wait even during another ongoing operation thereby improving the operability of the apparatus.

[Variation]

The embodiments have been described above. In these embodiments, particular configurations of the apparatus and system, particular processes, particular contents of a displayed screen, particular data formats, and particular executable operations are used, but these are not intended to be limiting in any manner.

For example, authentication does not have to be performed by use of a password. Authentication may be performed by use of any desired authentication information such as authentication-purpose data recorded in IC cards, digital certificates, or biometric information such as fingerprints, vein patterns, retina patterns, faces, or voice patterns. A plurality of information items may be combined. Further, provision may be made such that the right to perform an operation is determined on a user-specific or apparatus-specific basis by use of information that identifies a user or apparatus serving as a requester as an individual or by a group to which the user or apparatus belongs.

The image processing apparatus 10 does not have to be provided with an image scan unit or an image forming unit. The image processing apparatus 10 may be configured to accumulate image information received from an external source and to edit or output the data in response to an operation request.

The present invention is not limited to the handling of image information, and is applicable to any data processing apparatus that accumulates and processes other types of data.

The configurations described in the above embodiments and variations may be combined as appropriate as long as there is no conflict.

A program according to the present invention causes a computer to control a data processing apparatus to function as the image processing apparatus 10 as described above. When such program is executed by a computer, the above-described advantages are derived.

This program may be provided as being pre-stored in a memory means such as a ROM or HDD embedded in the computer, or may be provided through a nonvolatile record medium (memory) such as a CD-ROM, flexible disc, SRAM, EEPROM, or memory card. The program recorded in such memory is installed in a computer for execution by the CPU, or the CPU is instructed to read the program from the memory for execution, thereby achieving each function as described above.

It is also possible to execute the program by downloading the program from an external apparatus having a record medium with the program recorded therein or from an external apparatus having the program recorded in the memory means thereof.

In general, a memory serving as work space is necessary when a program is executed. When a particular function is not necessary, a program corresponding to such function may be configured not to run, thereby achieving efficient utilization of resources such as memories. A program stored in the memory medium is loaded for execution only when the corresponding function is necessary, thereby utilizing apparatus resources without wasting them.

As described heretofore, according to the data processing apparatus, program, and record medium of the present invention, the data processing apparatus can maintain the consistency of operation by preventing the occurrence of conflicting operations even when multiple requests to process stored data are received from a plurality of interfaces.

The application of the present invention can thus improve the reliability of operations of data processing apparatus.

Further, the present invention is not limited to these embodiments, but various variations and modifications may be made without departing from the scope of the present invention.

The present application is based on Japanese priority application No. 2005-350171 filed on Dec. 5, 2005, with the Japanese Patent Office, the entire contents of which are hereby incorporated by reference.

What is claimed is:

1. A data processing apparatus, comprising:
a memory unit configured to store data received from an information processing apparatus;
a receiving unit configured to receive operation requests, though respective interfaces, with respect to the data stored in the memory unit;
an authenticating unit configured to authenticate a requestor of an operation request;
an operation performing unit configured to perform an operation according to an operation request received by the receiving unit only if the authentication unit successfully authenticates a requester of the operation request when the data on which the operation is performed requires authentication; and
an operation prohibiting unit configured to prohibit the operation performing unit from performing a first operation corresponding to a first requester on given data until a second operation is completed if the authenticating unit successfully authenticates a second requester requesting the second operation to be performed on the given data.

2. The data processing apparatus as claimed in claim 1, further comprising a unit configured to inform the first requestor that the first operation is prohibited when the first requester requests to perform the first operation on the given data.

3. The data processing apparatus as claimed in claim 1, further comprising an operation request accumulating unit configured to accumulate an operation request requesting the first operation received from the first requestor and to supplies the accumulated operation request to the operation performing unit after prohibition by the operation prohibiting unit is disabled.

4. The data processing apparatus as claimed in claim 1, further comprising a unit configured to determine, in response to instruction from a user, types of operations that are to be prohibited by the operation prohibiting unit.

5. The data processing apparatus as claimed in claim 1, wherein types of operations that are prohibited by the operation prohibiting unit include a change of a data name, deletion of data, a change of an access control list corresponding to data, and a change of authentication information corresponding to data.

6. A data processing apparatus, comprising:
a memory unit configured to store data received from an information processing apparatus;
a receiving unit configured to receive operation requests, though respective interfaces, with respect to the data stored in the memory unit;
an authenticating unit configured to authenticate a requester of an operation request; and
an operation performing unit configured to perform an operation according to an operation request received by the receiving unit only if the authentication unit successfully authenticates a requester of the operation request when the data on which the operation is performed requires authentication,
wherein the operation performing unit is configured to perform a given operation corresponding to a given operation request from a given requestor upon successful authentication of the given requester requesting the given operation on given data and to continue to perform the given operation, even upon modification to information used in the authentication, until the given operation is completed as requested by the given requester authenticated prior to such modification.

7. A data processing apparatus, comprising:
a memory unit configured to store data received from an information processing apparatus;
a receiving unit configured to receive operation requests, though respective interfaces, with respect to the data stored in the memory unit;
an authenticating unit configured to authenticate a requestor of an operation request;
an operation performing unit configured to perform an operation according to an operation request received by the receiving unit only if the authentication unit successfully authenticates a requester of the operation request when the data on which the operation is performed requires authentication; and
a unit configured to cause the data processing unit to enter a specific operation mode for requesting an operation in response to a request from a requester,
wherein if a transition to the specific operation mode is made in response to a given request from a given requester, the authenticating unit is configured to authenticate the given requester by use of information used as of a time of the transition to the specific operation mode until the specific operation mode is completed.

8. A computer-readable medium having a program embodied therein for causing a computer to control a data processing apparatus to function as the data processing apparatus of claim 1.

9. A computer-readable medium having a program embodied therein for causing a computer to control a data processing apparatus to function as the data processing apparatus of claim 6.

10. A computer-readable medium having a program embodied therein for causing a computer to control a data processing apparatus to function as the data processing apparatus of claim 7.
